(19) United States
(12) Patent Application Publication
(10) Pub. No.: US 2022/0083817 A1
(43) Pub. Date: Mar. 17, 2022

(54) CASCADED CLUSTER-GENERATOR NETWORKS FOR GENERATING SYNTHETIC IMAGES

(71) Applicant: Robert Bosch GmbH, Stuttgart (DE)

(72) Inventor: Mehdi Noroozi, Leonberg (DE)

(21) Appl. No.: 17/374,529

(22) Filed: Jul. 13, 2021

(30) Foreign Application Priority Data
Sep. 14, 2020 (DE) 102020211475.7

(51) Int. Cl. G06K 9/62

(52) U.S. Cl. CPC G06K 9/6262; G06K 9/628; G06K 9/6256; G06K 9/6218

(57) ABSTRACT

A method for training a combination of a clustering network and a generator network. The method includes optimizing parameters that characterize the behavior of the discriminator network with the goal of improving the accuracy with which the discriminator network distinguishes between real pairs including real images and indications of clusters, and fake pairs including fake images and indications of clusters from which they are produced; and optimizing parameters that characterize the behavior of the clustering network and parameters that characterize the behavior of the generator network with the goal of deteriorating the accuracy.

### CROSS REFERENCE

The present application claims the benefit under 35 U.S.C. § 119 of German Patent Application No. 102020211475.7 filed on Sep. 14, 2020, which is expressly incorporated herein by reference in its entirety.

### FIELD

The present invention relates to the adversarial training of generator networks for producing synthetic images that may, inter alia, be used for training image classifiers.

### BACKGROUND INFORMATION

Image classifiers need to be trained with training images for which “true” classification scores that the classifier should assign to the respective image are known. Obtaining a large set of training images with sufficient variability is time-consuming and expensive. For example, if the image classifier is to classify traffic situations captured with one or more sensors carried by a vehicle, long test drives are required to obtain a sufficient quantity of training images. The “true” classification scores needed for the training frequently need to be obtained by manually annotating the training images, which is also time-consuming and expensive. Moreover, some traffic situations, such as a snow storm, occur only rarely during the capturing of the training images.

To alleviate the scarcity of training images, generative adversarial networks (GANs) may be trained to generate synthetic images that look like real images and may be used as training images for image classifiers. Conditional GANs (cGANs) may be used to generate synthetic images that belong to a certain mode of the distribution of realistic images. For example, a conditional GAN may generate synthetic images that belong to a particular class of the classification.

German Patent Application No. DE 10 2018 204 494 B3 describes a method for generating synthetic radar signals as training material for classifiers.

### SUMMARY

The present invention uses a combination of a clustering network and a generator network to produce synthetic images. In accordance with an example embodiment of the present invention, the generator network works somewhat akin to the generator in a previous cGAN in that it is configured to map a noise sample and some additional information to a synthetic image. But unlike in cGANs, this additional information is not some class label or classification score according to a human-provided classification. Rather, the additional information is an indication of a target cluster to which the sought synthetic image shall belong. The clusters are in turn determined by a clustering network. The clustering network is configured to map an input image to a representation in a latent space. This representation is indicative of a cluster to which the input image belongs.

The representation in the latent space may, for example, be a direct assignment of the input image to a cluster, such as “this input image belongs to that cluster”. However, the representation in the latent space as such may also be just a point in some latent space that is multi-dimensional, but has much lower dimensionality than the input image. The points in the latent space may then be divided into clusters in a second step.

The main difference between these clusters, on the one hand, and class labels, on the other hand, is that the clusters are generated from input images in an unsupervised manner. This means that even if it is pre-set in advance that a certain set of input images is to be divided into a certain number of clusters, it is not known beforehand what exactly these clusters signify. For example, if a set of input images of traffic scenes is divided into 10 clusters, these clusters might represent different objects contained in the images, but might just as well represent different weather conditions in which the images were taken. By contrast, the assignment of class labels to input images is a human-imposed condition.

The present invention provides a method for training said combination of the clustering network and the generator network. In accordance with an example embodiment of the present invention, in the course of this method, a set of training input images is provided. The clustering network maps these training input images to representations that are indicative of clusters to which the training input images belong. That is, at the latest after all training input images have been processed by the clustering network, the clusters are known, and it is known which training input image belongs to which cluster.

Noise samples are drawn from a random distribution. Also, indications of target clusters are drawn from the set of clusters identified by the clustering network. The generator network takes combinations of noise samples and indications of target clusters as input and generates a fake image. The combination of this fake image and the indication of the target cluster with which it was produced forms a fake pair. So the fake pair may, for example, consist of a generated fake image and a number or other identifier of the target cluster.

Real images are drawn from the set of training input images. Each real image is combined with an indication of the cluster to which it was assigned by the clustering network, so that a real pair is formed. Thus, the real pair may consist of a real image and a number or other identifier of the cluster to which it belongs according to the clustering network.

In accordance with an example embodiment of the present invention, for adversarial training, a mixture of real pairs and fake pairs is fed into a discriminator network that is configured to distinguish real pairs from fake pairs. In particular, this discriminator may exploit two kinds of signals to determine that an inputted pair is a fake pair, rather than a real pair: First, if the image appears not to be realistic on its own, the discriminator may determine that it is a fake image, and that the inputted pair is therefore a fake pair. This may, for example, happen if a generator produces an imperfect image with visible artifacts, rather than a realistic image. Second, if the image looks realistic on its own, but its assignment to a particular cluster appears not to be realistic, the discriminator may determine that the inputted pair is a fake pair. This may, for example, happen if a pair combines a perfectly generated rendering of a car with a cluster that basically contains only trees, rather than with a cluster that basically contains only cars. It is a goal of the training that, for all clusters identified by the clustering network, the generator is able to generate realistic images that may pass for real images belonging to the respective cluster.

Parameters that characterize the behavior of the discriminator network are optimized with the goal of improving the accuracy with which the discriminator network distinguishes between the real pairs and fake pairs. At the same time, parameters that characterize the behavior of the clustering network and parameters that characterize the behavior of the generator network are optimized with the goal of deteriorating mentioned accuracy. That is, the clustering network and the generator network are working hand in hand and competing against the discriminator network.

In contrast to cGAN, the combination of the clustering network and the generator network, in accordance with an example embodiment of the present invention, does not require any human intervention to assign class labels to training input images, such that the later generated images may be conditioned on those class labels. Rather, just plain unlabeled training input images are sufficient. This brings about the advantage that the effort and expense for the manual labelling is not necessary. But this is not the only advantage.

Rather, it was found that in many cases, the division of a concrete set of training input images into the clusters by the clustering network is more appropriate than a division of the same set of training input images into classes of a human-imposed classification. That is, the clustering network learns automatically which distinguishing features are present in the input images and may be used for dividing the input images into different clusters.

It therefore depends on the composition of the set of training input images which division into clusters is appropriate. In particular, dividing the set of training input images into clusters with respect to a certain property in a meaningful manner requires some examples for each property to be present.

For example, dividing a set of training input images into four clusters representing the four seasons makes no sense if almost all of the training input images were taken in only one single season. In another example, dividing a set of training input images into 1000 clusters representing different objects makes no sense if only 500 different objects are present in the whole set of training images.

Thus, the clustering by the clustering network only outputs a division of the set of training input images according to features that are actually present and discernible in this concrete set of training input images. This means that the images generated by the generator and conditioned on a certain target cluster relate to a cluster that is in fact discernible from the set of training input images. So given a set of training images that were all taken in one single season, there would be no clusters relating to different seasons, and the generator network would make no attempt to “guess” images of three seasons for which it has never seen any training input image. In general, the generator cannot generate any data from a mode of the distribution that is not present in the training set. With the present self-labeled cGAN, this limitation is automatically enforced, and for the images that the self-labeled cGAN does produce, sufficient basis in the training set is guaranteed.

The ultimate result is that after a combination of a clustering network and a generator network has been trained as described here, the images generated by the generator network can be expected to be more realistic than images previously generated by cGANs. Moreover, the available classes for realistic image generation are determined automatically. The user does not have to determine manually which classes are discernible from the training input images. Rather, the user directly receives a feedback of the kind, “this training data set is good for distinguishing between these classes”.

The division of the set of training input images that the clustering network makes may be used as a feedback how to further augment the set of training input images if another division is desired. For example, if a division into four clusters is desired, but the clusters are formed according to some other property than the seasons in which the images were taken, this means that more training input images taken in different seasons are needed in order to get clusters divided along the lines between seasons. It may also become necessary to increase the number of clusters.

In any cGAN, the optimization according to the competing goals may, for example, be performed according to a predetermined loss function. For example, such a loss function L_{adv} may take the form

L_{adv}(G, D)=E_{x,y˜PR}[log D(x, y)]+E_{z˜PZ,c˜PC}[log(1−D(G(z, c), [symbol] _{K}(c)))].

Herein, G represents the generator network, and D represents the discriminator network. The use of these as arguments of the loss function and as quantities over which to minimize or maximize is shorthand for the parameters that characterize the behavior of the respective network. E signified computation of an expectancy value over indicated distributions.

PR is the distribution of real pairs of images x and labels y to which these images x truly belong. PZ is a distribution of noise samples z in a latent space, e.g., a multivariate Gaussian. PC is a continuous distribution of indications c of target labels, and 1_{K}(c) encodes such an indication c in a one-hot vector of dimension K. K is the number of available labels.

For a self-labelled cGAN, in the formula above, the label y to which an image truly belongs is not known because no human labelling takes place. Rather, the clustering network C may be understood to provide, for every image x, a probability p(y|x) that the image x belongs to the cluster y that is now used in place of the label. Also, the indications c of target labels now become indications of target clusters provided by C. K becomes the number of clusters, which may be pre-set for the clustering or be a result of the clustering, depending on the type of clustering used. With this, the adversarial loss L_{adv} may be rewritten as

L_{adv}(G, C, D)=E_{x,˜PR}[logD(x, p(y|x))]+E_{z˜PZ,c˜PC}[log(1−D(G(z, c), [symbol] _{K}(c)))].

As discussed above, the parameters that characterize the behavior of the generator network D are optimized with the goal of maximizing this adversarial loss L_{adv}, whereas the parameters that characterize the behavior of the clustering network C and the generator network G are optimized to minimize L_{adv}.

The number K of clusters may preferably be pre-set as a hyperparameter. Then, for example, K-means clustering may be used. In K-means clustering, K centroids are initially randomly distributed in the latent space, and then moved such that the sum of the squared distances of the representations from their respective centroid is minimized.

In a particularly advantageous embodiment, the value of this hyperparameter K is optimized for a maximum diversity of fake images produced by the generator network. For example, this diversity may be measured in terms of the Fréchet Inception Distance, FID. In this manner, the number of different clusters is automatically set to the number that the set of training input images actually supports. No more attempt is made to interpret a distinction between clusters that is in fact not discernible into the set of training input images.

In a particularly advantageous embodiment, the generator network is additionally trained with the goal that the fake image is mapped to an indication of the target cluster by the clustering network. For example, on top of the loss function L_{adv}(G,C,D), another additive term

Lₘᵢ(G)=E_{z˜PZ,c˜PC}−log[p(y=c|G(z, c))]

may be considered. The additional training goal serves to penalize a degenerate “cheating” solution to which the clustering network C and the generator network G might resort in order to hide it from the discriminator D that the assignment of an image to a certain cluster is fake: If the clustering network just randomizes the assignment of clusters to input images, the combining of a realistically generated fake image with any target cluster cannot be any worse than that. That is, if the fake image looks realistic, the fake pair in which it is comprised may pass for a real pair. Said additional training goal and loss Lₘᵢ(G) serve to avoid this.

In a further particularly advantageous embodiment, the clustering network is additionally trained with the goal that the clustering network maps a transformed version of the input image that has been obtained by subjecting the input image to one or more predetermined disturbances to a representation that is indicative of the same cluster to which the input image belongs. In this manner, it may be taken into account that the predetermined disturbances do not change the semantic meaning of the image, so that a change of cluster is not appropriate. For example, another additive contribution

$${L}_{aug} ( C ) = {E}_{x ∼ PR} {\sum }_{c = 1}^{K} - p ( y = c \vert {x}_{t} ) log [ p ( y = c \vert x ) ]$$

to the loss function may be considered. Herein, xₜ is the transformed version of the image.

For example, the predetermined disturbances may comprise one or more of cropping, color jittering, and flipping.

When the total loss function is assembled from L_{adv}(G, C, D), Lₘᵢ(G), L_{aug}(C) and possibly more contributions, the contributions may be weighted relatively to one another in order to prioritize the training goals. The total loss function is maximized with the respect to the parameters that characterize the behavior of the discriminator network D. The result is in turn minimized with respect to the parameters that characterize the behavior of the clustering network C and the behavior of the generator network G.

The clustering network may additionally be trained with the goal of maximizing the mutual information between a representation to which the clustering network maps the input image on the one hand, and a representation to which the clustering network maps the transformed version of the input image on the other hand. This means that if the one is known, this already gives a hint what the other may be.

Also, the generator network may be additionally trained with the goal of maximizing the mutual information between a cluster to which the clustering networks assigns a fake image on the one hand, and the indication of the target cluster with which this fake image was produced on the other hand. This improves the self-consistency.

Mutual information may, for example, be measured in terms of cross entropy.

In a further particularly advantageous embodiment of the present invention, a discriminator network may be chosen that separately outputs, for a pair inputted to the discriminator network,
on the one hand, whether the image comprised in the pair is a real image or a fake image, and
on the other hand, whether the pair as a whole is a real pair or a fake pair.

If the discriminator network is built in this manner, the adversarial loss function may comprise terms that depend on images as well as terms that depend on pairs.

The present invention also provides a method for generating synthetic images based on a given set of images. In accordance with an example embodiment of the present invention, in the course of this method, a combination of a clustering and a generator network may be trained as discussed above, using the given set of images as training images. Noise samples are then drawn from a random distribution, and indications of target clusters are drawn from the set of clusters identified by the clustering network during training. Using the generator network, the noise samples and the indications of the target clusters are mapped to the sought synthetic images.

As discussed before, during training of the combination of the clustering network and the generator network, the clustering network learns in an unsupervised manner which features of the training input image may be used to partition the set of training input images into clusters. This “representation learning” captures basic features of the training input images and may be used to make the task of classifying images easier: Once the clustering network is trained, training for a particular image classification task no longer needs to start from scratch. Rather, such training may start from the representations to which the clustering network maps input images. That is, the training does not start on the raw images, but on a form of the images on which some work has already been done.

Thus, an image classifier that is configured to map an input image to a classification score with respect to one or more classes out of a predetermined set of available classes may comprise:
a clustering network that is trained according to the method described before; and
a classifier network that is configured to map representations produced by the clustering network to classification scores with respect to one or more classes from predetermined set of available classes.

This makes the job of the classifier network much easier. An figurative analogy to this approach is that it is much easier to launch a probe to the moon from a base in Earth orbit (corresponding to the trained clustering network) than it is to launch the same probe from the face of the Earth.

The present invention also provides a method for training said image classifier that comprises a cascade of a clustering network and a classifier network. In accordance with an example embodiment of the present invention, in the course of this method, training images and corresponding training classification scores (“labels”) are provided. The training images are mapped to representations in the latent space by the clustering network. The classifier network maps the so-obtained representations to classification scores.

These classification scores are compared to the training classification scores. The outcome of this comparison is rated with a predetermined loss function. Parameters that characterize the behavior of the classifier network are optimized with the goal of improving the rating by the loss function that results when the processing of training images is continued.

For example, such training may be divided into steps and epochs. After every step, an update to the parameters of the classifier network is determined based on the rating by the loss function. For example, gradients of the loss function with respect to the parameters may be back-propagated through the classifier network. An epoch is completed when all available training images have been used once. Usually, a training extends over many epochs.

It is a particular advantage of this training method that the “representation learning” of the classifier network is fairly generic, meaning that one and the same trained classifier network may be used for many classification tasks. To switch from one classification task to the next one, only a new training or retraining of the classifier network is required.

Therefore, in a particularly advantageous embodiment of the present invention, at least two classifier networks are trained with the same clustering network but different training images and classification scores.

The methods described herein may be wholly or partially computer-implemented. They may thus be embodied in a computer program that may be loaded on one or more computers. The present invention therefore also provides a computer program with machine readable instructions that, when executed by one or more computers, cause the one or more computers to perform one or more methods as described above. In this respect, embedded systems and control units, e.g., for use in vehicles or other machines, that may execute program code are to be regarded as computers as well.

The present invention also provides a non-transitory computer-readable storage medium, and/or a download product, with the computer program. A download product is a digital product that may be delivered over a computer network, i.e., downloaded by a user of the computer network, that may, e.g., be offered for sale and immediate download in an online shop.

Also, one or more computers may be equipped with the computer program, with the non-transitory computer-readable storage medium, and/or with the download product.

### BRIEF DESCRIPTION OF EXAMPLE EMBODIMENTS

In the following, the present invention is illustrated using Figures without any intention to limit the scope of the present invention. The Figures show:

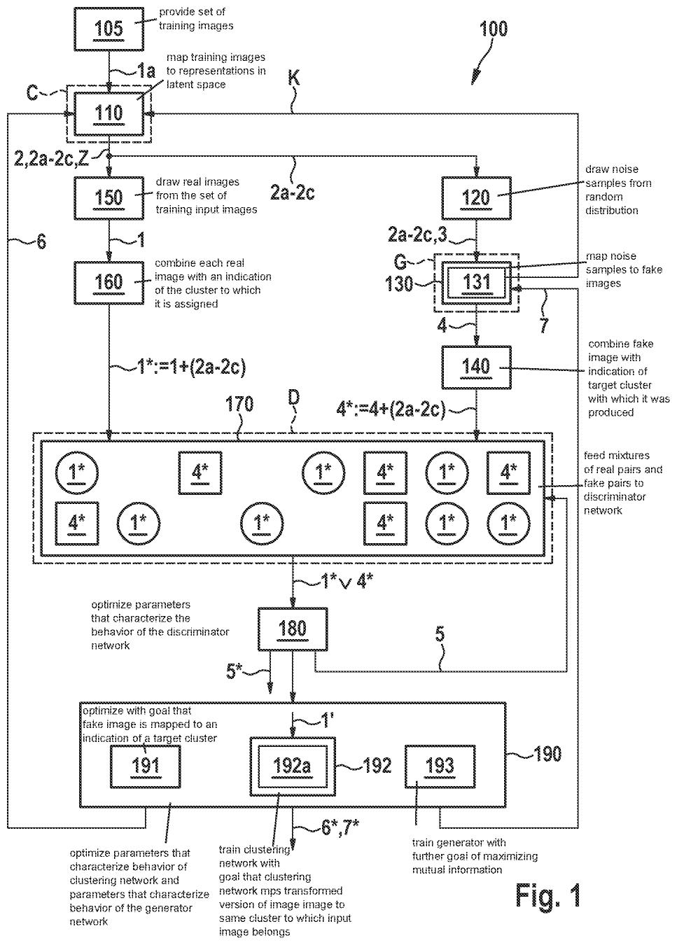

FIG. 1 shows an exemplary embodiment of the method 100 for training a combination of a clustering network C and a generator network G, in accordance with the present invention.

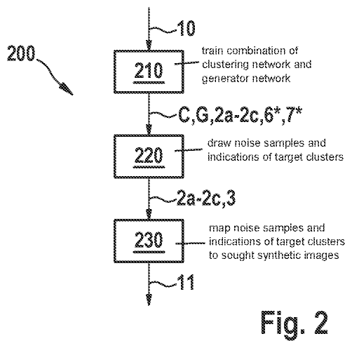

FIG. 2 shows an exemplary embodiment of the method 200 for generating synthetic images 11 from given images 10, in accordance with the present invention.

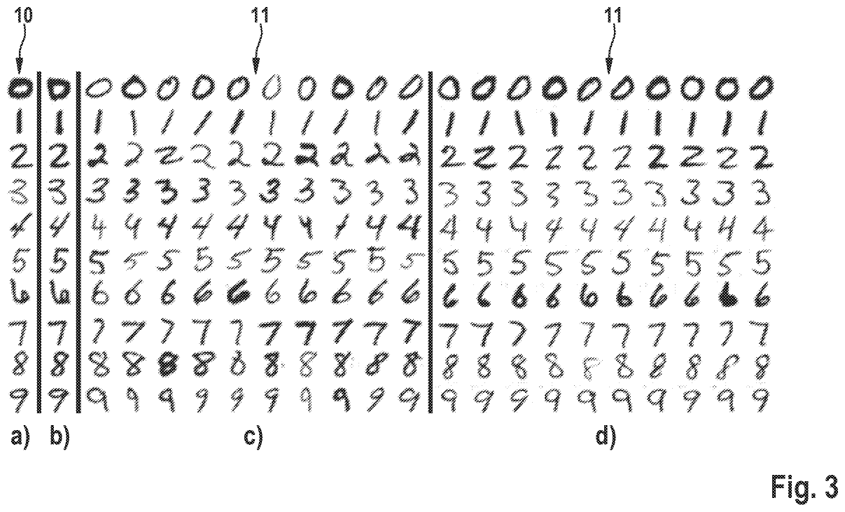

FIG. 3 shows examples of synthetic images 11 generated by the method 200 based on the MNIST dataset of handwritten digits.

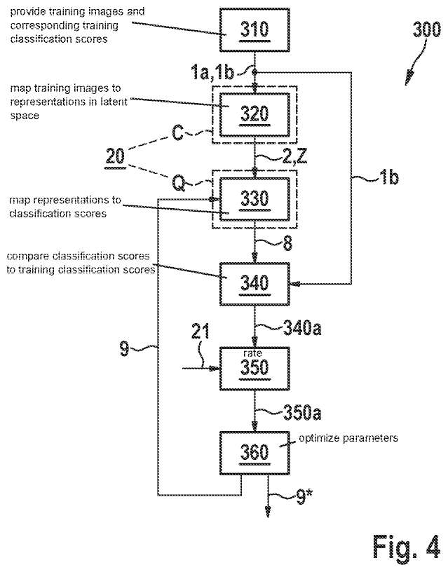

FIG. 4 shows exemplary embodiment of the method 300 for training an image classifier 20, in accordance with the present invention.

### DETAILED DESCRIPTION OF EXAMPLE EMBODIMENTS

FIG. 1 is a schematic flow chart of an embodiment of the method 100 for training a combination of a clustering network C and a generator network G.

In step 105, a set of training input images 1a is provided. In step 110, the clustering network C maps these training input images to representations 2 in a latent space Z. Each representation 2 is indicative of a cluster 2a-2c to which the input image 1 belongs. The number of clusters 2a-2c may be known in advance (e.g., a pre-set number K), but the centers of these clusters 2a-2c and the boundaries between them emerge during the processing of many training input images 1a.

In step 120, noise samples 3 are drawn from a random distribution. Also, from the set of clusters 2a-2c previously identified by the clustering network C, indications of target clusters 2a-2c are drawn (sampled). In step 130, the noise samples 3 and the indications of target clusters 2a-2c are mapped to fake images 4 by the generator network G. In step 140, each fake image 4 is combined with the indication of the target cluster 2a-2c with which it was produced to form a fake pair 4*.

Optionally, according to block 131, a pre-set number K of clusters 2a-2c may be optimized for a maximum diversity of fake images 4 produced by the generator network G.

In step 150, real images 1 are drawn from the set of training input images 1a. In step 160, each real image 1 is combined with an indication of the cluster 2a-2c to which the clustering network C has assigned it to form a real pair 1*.

A mixture of real pairs 1* and fake pairs 4* is fed to the discriminator network D in step 170. The discriminator D outputs a decision 1* v 4* whether the inputted pair is a real pair 1* or a fake pair 4*.

In step 180, parameters 5 that characterize the behavior of the discriminator network D are optimized with the goal of improving the accuracy with which the discriminator network D distinguishes between real pairs 1* and fake pairs 4*. The finally trained state of these parameters is labelled with the reference sign 5*.

In tandem with this training, in step 190, parameters 6 that characterize the behavior of the clustering network C and parameters 7 that characterize the behavior of the generator network G are optimized with the goal of deteriorating the accuracy of the decisions 1*∨4* made by the discriminator network D. The finally trained states of the parameters 6 and 7 are labelled with the reference signs 6* and 7*, respectively.

In particular, according to block 191, the additional optimization goal that the fake image 4 is mapped to an indication of the target cluster 2a-2c by the clustering network C may be pursued when training the generator network G.

According to block 192, the clustering network C may be further trained with the goal that the clustering network C maps a transformed version 1′ of the input image 1 that has been obtained by subjecting the input image 1 to one or more predetermined disturbances to a representation 2 that is indicative of the same cluster 2a-2c to which the input image 1 belongs.

According to block 192a, the clustering network C may be additionally trained with the goal of maximizing the mutual information between a representation 2 to which the clustering network C maps the input image 1 on the one hand, and a representation 2 to which the clustering network C maps the transformed version 1′ of the input image 1 on the other hand.

According to block 193, the generator 193 may be trained with the further goal of maximizing the mutual information between a cluster 2a-2c to which the clustering networks assigns a fake image 4 on the one hand, and the indication of the target cluster 2a-2c with which this fake image 4 was produced on the other hand.

FIG. 2 is a schematic flow chart embodiment of the method 200 for generating synthetic images based on a given set of images 10.

In step 210, a combination of a clustering network C and a generator network G is trained by the method 100 described before, using the given set of images as training images 1a.

In step 220, noise samples 3 are drawn from a random distribution, and indications of target clusters 2a-2c are drawn from the set of clusters 2a-2c identified by the clustering network C during training

In step 230, the noise samples 3 and the indications of target clusters 2a-2c are mapped to the sought synthetic images 11 by the generator network G.

FIG. 3 shows examples of synthetic images 11 generated by the method 200 just described.

In FIG. 3, image (a) is one of the images from the given set of images 10. Here, images of handwritten digits from the well-known MNIST dataset were used as given images 10. Image (b) is an almost exact GAN reconstruction of the given image 10.

Synthetic images 11 were now produced. Images (c) and (d) show exemplary synthetic images 11 for the same cluster to which the given image 10 was assigned.

Image (c) shows ten synthetic images 11 that were produced with a pre-set number K of clusters 2a-2c for the clustering set to 10. This number K of clusters 2a-2c causes at least the category of the given image 10 to be reproduced, but some of the synthetic digits have a style that is quite different from the style in the given image 10.

Image (d) shows ten synthetic images 11 that were produced with the pre-set number K of clusters set to 50. This number of clusters is sufficient to encode also the style of the respective digit in the given image 10. As a consequence, this style is reproduced in the synthetic images 11.

FIG. 4 is a schematic flow chart of the method 300 for training an image classifier 20 that comprises a clustering network C and a generator network G. The classifier 20 is configured to map an input image 1 to a classification score 8 with respect to one or more classes 8a-8c out of a predetermined set of available classes 8a-8c.

In step 310, training images 1a and corresponding training classification scores 1b are provided.

In step 320, the clustering network C maps training images 1a to representations 2 in the latent space Z.

In step 330, the classifier network Q maps the representations 2 to classification scores 8.

In step 340, the classification scores 8 are compared to the training classification scores 1b. The outcome 340a of this comparison 340 is rated in step 350 with a predetermined loss function 21.

In step 360, parameters 9 that characterize the behavior of the classifier network Q with the goal of improving the rating 350a by the loss function 21 that results when the processing of training images 1a is continued. The finally obtained state of the parameters 9 is labelled with the reference sign 9*.

What is claimed is:

1. A method for training a combination of: (i) a clustering network that is configured to map an input image to a representation in a latent space, wherein the representation is indicative of a cluster to which the input image belongs, and (ii) a generator network that is configured to map a noise sample and an indication of a target cluster to an image that belongs to the target cluster, the method comprising the following steps:
providing a set of training input images;
mapping, by the clustering network, the training input images to representations that are indicative of clusters to which the training input images belong;
drawing noise samples from a random distribution and indications of target clusters from a set of clusters identified by the clustering network;
mapping, by the generator network, the noise samples and the indications of target clusters to fake images, and combining each fake image of the fake images with the indication of the target cluster with which it was produced, to form a fake pair;
drawing real images from the set of training input images;
combining each real image of the real images with an indication of the cluster to which it was assigned by the clustering network, to form a real pair;
feeding a mixture of the real pairs and the fake pairs to a discriminator network that is configured to distinguish real pairs from fake pairs;
optimizing parameters that characterize a behavior of the discriminator network with a goal of improving an accuracy with which the discriminator network distinguishes between real pairs and fake pairs; and
optimizing parameters that characterize a behavior of the clustering network and the parameters that characterize the behavior of the generator network with a goal of deteriorating the accuracy.

2. The method of claim 1, wherein the generator network is additionally trained with a goal that the fake image is mapped to an indication of the target cluster by the clustering network.

3. The method of claim 1, wherein the clustering network is additionally trained with a goal that the clustering network maps a transformed version of the input image that has been obtained by subjecting the input image to one or more predetermined disturbances to a representation that is indicative of the same cluster to which the input image belongs.

4. The method of claim 3, wherein the predetermined disturbances include one or more of: cropping, and/or color jittering and/or flipping.

5. The method of claim 3, wherein the clustering network is additionally trained with a goal of maximizing mutual information between a representation to which the clustering network maps the input image on the one hand, and a representation to which the clustering network maps the transformed version of the input image on the other hand.

6. The method of claim 1, wherein the discriminator network is chosen that separately outputs, for a pair inputted to the discriminator network:
on the one hand, whether the image in the pair is a real image or a fake image, and
on the other hand, whether the pair as a whole is a real pair or a fake pair.

7. The method of claim 1, wherein the generator network is additionally trained with a goal of maximizing mutual information between a cluster to which the clustering networks assigns a fake image on the one hand, and the indication of the target cluster with which this fake image was produced on the other hand.

8. The method of claim 1, wherein the clustering network divides the training input images into a pre-set number K of clusters.

9. The method of claim 8, further comprising:
optimizing the number K of clusters for a maximum diversity of fake images produced by the generator network.

10. A method for generating synthetic images based on a given set of images, comprising the following steps:
training a combination of a clustering network and a generator network, using the given set of images as a set of training images, the clustering network being configured to map an input image to a representation in a latent space, wherein the representation is indicative of a cluster to which the input image belongs, and the generator network being configured to map a noise sample and an indication of a target cluster to an image that belongs to the target cluster, the training including:
providing the set of training input images,
mapping, by the clustering network, the training input images to representations that are indicative of clusters to which the training input images belong,
drawing noise samples from a random distribution and indications of target clusters from a set of clusters identified by the clustering network,
mapping, by the generator network, the noise samples and the indications of target clusters to fake images, and combining each fake image of the fake images with the indication of the target cluster with which it was produced, to form a fake pair,
drawing real images from the set of training input images,
combining each real image of the real images with an indication of the cluster to which it was assigned by the clustering network, to form a real pair,
feeding a mixture of the real pairs and the fake pairs to a discriminator network that is configured to distinguish real pairs from fake pairs,
optimizing parameters that characterize a behavior of the discriminator network with a goal of improving an accuracy with which the discriminator network distinguishes between real pairs and fake pairs, and
optimizing parameters that characterize a behavior of the clustering network and the parameters that characterize the behavior of the generator network with a goal of deteriorating the accuracy;
drawing noise samples from a random distribution and indications of target clusters from the set of clusters identified by the clustering network during the training; and
mapping, by the generator network, the noise samples and the indications of target clusters to the sought synthetic images.

11. A method for training an image classifier that is configured to map an input image to a classification score with respect to one or more classes out of a predetermined set of available classes, wherein the image classifier includes a trained clustering network, and a classifier network that is configured to map representations produced by the clustering network to classification scores with respect to one or more classes from the predetermined set of available classes, the method comprising the following steps:
providing training images and corresponding training classification scores;
mapping, by the clustering network, training images to representations in a latent space;
mapping, by the classifier network, the representations to classification scores;
comparing the classification scores to the training classification scores;
rating an outcome of the comparison with a predetermined loss function; and
optimizing parameters that characterize a behavior of the classifier network with a goal of improving an outcome of the rating by the loss function that results when processing of the training images is continued.

12. The method as recited in claim 11, wherein the clustering network is trained with a generator network by:
providing a set of training input images;
mapping, by the clustering network, the training input images to representations that are indicative of clusters to which the training input images belong;
drawing noise samples from a random distribution and indications of target clusters from a set of clusters identified by the clustering network;
mapping, by the generator network, the noise samples and the indications of target clusters to fake images, and combining each fake image of the fake images with the indication of the target cluster with which it was produced, to form a fake pair;
drawing real images from the set of training input images;
combining each real image of the real images with an indication of the cluster to which it was assigned by the clustering network, to form a real pair;
feeding a mixture of the real pairs and the fake pairs to a discriminator network that is configured to distinguish real pairs from fake pairs;
optimizing parameters that characterize a behavior of the discriminator network with a goal of improving an accuracy with which the discriminator network distinguishes between real pairs and fake pairs; and
optimizing parameters that characterize a behavior of the clustering network and the parameters that characterize the behavior of the generator network with a goal of deteriorating the accuracy.

13. The method of claim 11, wherein at least two classifier networks are trained with the same clustering network but different training images and classification scores.

14. A non-transitory computer-readable storage medium on which is stored a computer program for training a combination of: (i) a clustering network that is configured to map an input image to a representation in a latent space, wherein the representation is indicative of a cluster to which the input image belongs, and (ii) a generator network that is configured to map a noise sample and an indication of a target cluster to an image that belongs to the target cluster, the computer program, when executed by one or more computers, causing the one or more computers to perform the following steps:
providing a set of training input images;
mapping, by the clustering network, the training input images to representations that are indicative of clusters to which the training input images belong;
drawing noise samples from a random distribution and indications of target clusters from a set of clusters identified by the clustering network;
mapping, by the generator network, the noise samples and the indications of target clusters to fake images, and combining each fake image of the fake images with the indication of the target cluster with which it was produced, to form a fake pair;
drawing real images from the set of training input images;
combining each real image of the real images with an indication of the cluster to which it was assigned by the clustering network, to form a real pair;
feeding a mixture of the real pairs and the fake pairs to a discriminator network that is configured to distinguish real pairs from fake pairs;
optimizing parameters that characterize a behavior of the discriminator network with a goal of improving an accuracy with which the discriminator network distinguishes between real pairs and fake pairs; and
optimizing parameters that characterize a behavior of the clustering network and the parameters that characterize the behavior of the generator network with a goal of deteriorating the accuracy.

15. One or more computers configured to train a combination of: (i) a clustering network that is configured to map an input image to a representation in a latent space, wherein the representation is indicative of a cluster to which the input image belongs, and (ii) a generator network that is configured to map a noise sample and an indication of a target cluster to an image that belongs to the target cluster, the one or more computers configured to:
provide a set of training input images;
map, by the clustering network, the training input images to representations that are indicative of clusters to which the training input images belong;
draw noise samples from a random distribution and indications of target clusters from a set of clusters identified by the clustering network;
map, by the generator network, the noise samples and the indications of target clusters to fake images, and combine each fake image of the fake images with the indication of the target cluster with which it was produced, to form a fake pair;
draw real images from the set of training input images;
combine each real image of the real images with an indication of the cluster to which it was assigned by the clustering network, to form a real pair;
feed a mixture of the real pairs and the fake pairs to a discriminator network that is configured to distinguish real pairs from fake pairs;
optimize parameters that characterize a behavior of the discriminator network with a goal of improving an accuracy with which the discriminator network distinguishes between real pairs and fake pairs; and
optimize parameters that characterize a behavior of the clustering network and the parameters that characterize the behavior of the generator network with a goal of deteriorating the accuracy.
